(19) United States
(12) Patent Application Publication
(10) Pub. No.: US 2018/0099549 A1
(43) Pub. Date: Apr. 12, 2018

(54) IMPACT MITIGATION VEHICLE COVER

(71) Applicant: Robb POPADYNETZ, Calgary (CA)

(72) Inventor: Robb POPADYNETZ, Calgary (CA)

(21) Appl. No.: 15/782,608

(22) Filed: Oct. 12, 2017

Related U.S. Application Data
(60) Provisional application No. 62/407,196, filed on Oct. 12, 2016.

(51) Int. Cl. B60J 11/04

(52) U.S. Cl. CPC B60J 11/04

(57) ABSTRACT

A storable vehicle cover has a base sheet provided with one or more pockets for receiving removable energy-absorbing hail guards when needed, and which can be removed when not in use for ease of storage. The base sheet, with hail guards removed, is compact and readily stored, even for storage with the vehicle itself. One or more of the pockets is recloseable. In an emergency, the pockets can accept impromptu material as guards, including articles of clothing. Some smaller hail guards can be permanently secured within a pocket.

### CROSS REFERENCE TO RELATED APPLICATIONS

This application claims the benefits under 35 U.S.C 119(e) of U.S. Provisional Application Ser. No. 62/407,196, filed Oct. 12, 2016 the entirely of which is incorporated fully herein by reference.

### FIELD

Embodiments herein relate to vehicle covers for mitigation of hail damage, more particularly to covers with energy absorbing inserts.

### BACKGROUND

In a Jun. 10, 2016 article by the Insurance Institute for Highway Safety, cumulative payouts for vehicle damage for 2008-14 were in the order of $7 billion. The Insurance Institute for Highway Safety is an independent, nonprofit scientific and educational organization in the United States. In their article, data from the 31 companies, representing 87 percent of the comprehensive coverage exposure stored in the Highway Loss Data Institute's database and based on more than 491 million insured vehicle years and more than 1.5 million claims. Payouts in 2014 alone were $1.33 billion.

Further, as individual owners of affected vehicles also know, there is also the inconvenience cost in having a claim evaluated and the repair made. Many claims result in the vehicle being written off or listed as salvage, requiring the affected owner to engage in the replacement process.

Car dealerships regularly suffer catastrophic losses with exposed vehicles on the lot. Some lots are transitioning to expensive tented structures for outside vehicle storage, in part for reduction in related repair and insurance costs and also for the lost time and inventory replacement issues.

Prediction of when and where a hail storm will strike is still an uncertain science. The vehicle owners and their vehicles are often caught away from shelter, or shelter is unavailable.

In the art, it is known to provide a hail-mitigating cover by suspending a sheet of material above the vulnerable surface, such as a sheet secured and suspended taut above and across supporting standoff members resting on the vehicle, including: Foam members in U.S. Pat. No. 5,401,074 to Timerman, inflatable tubes in U.S. Pat. No. 6,044,881 to Welch et al., and leaf spring members in U.S. Pat. No. 4,858,985 to Wojcik. Such systems are elaborate, expensive and bulky. Others have used a multilayer cover, the entirely and permanently configured with multiple layers of impact absorbing material and sheet material including: a plurality of energy absorbing rods sandwiched between opposing sheet material in U.S. Pat. No. 5,664,865 to Henke et al., laminated multiple layers of shock-absorbing material sandwiched between panels in U.S. Pat. No. 6,220,648 to Daniel, U.S. Pat. No. 5,800,006 to Pettigrew, and U.S. Pat. No. 6,070,629 to Whiteside. Such systems are expensive and even more bulky than the suspended sheet versions above.

There is still a need for means to protect individual vehicles both in advance when possible, quickly mobilized immediately before a hail event, and conveniently stored in a compact form between uses.

### SUMMARY

In embodiments disclosed herein, a storable vehicle cover system or cover is provided, the cover having a base sheet provided with one or more pockets for the ease of insertion of hail guards for use, and removal when not in use. Some of the guards can be temporarily installed for use and others of which could be of a more permanent nature. The temporary hail guards are removably insertable into the pockets. The base sheet, with hail guards removed, is compact and readily stored, even for storage with the vehicle itself. Some hail guards, usually smaller that the removable guards and of a more troublesome or time consuming nature in the installation thereof, can be permanently inserted into the pockets, whilst, larger guards are more readily inserted for use and thereafter removable for storage.

The cover can be applied to the entirety of the vehicle's exposed surfaces, as is the case for cars and trucks, or parts thereof, such as in the case of a car hood along or a motorcycle vehicle's gas tank.

In one aspect an impact mitigation cover for a vehicle is provided comprising a base sheet conforming in surface area and peripheral shape for securing to the vehicle and one or more pockets arranged on an outer surface thereon, each pocket corresponding to a damage-vulnerable surface of the vehicle and sized corresponding thereto, the pocket having an opening therein for the insertion of an impact energy-absorbing guard therein for use and removal therefrom for storage.

In another aspect, an impact mitigation cover for a vehicle comprises a base sheet conforming in size and shape for securing about the vehicle and one or more pockets arranged on an outer surface thereon. Each pocket corresponds in location to a damage-vulnerable surface of the vehicle and sized corresponding thereto, at least one of the pockets having an opening therein for the insertion of an correspondingly sized impact energy-absorbing guard therein for use, and for removal therefrom for storage.

In another aspect, the pockets are recloseable having a releasable fastener, such as hook and loop fasteners or zippers for securing the guard within.

In yet another aspect, a method for impact mitigation of a vehicle comprises unfolding a base sheet for a vehicle cover; installing the base sheet about the vehicle with one or more pockets arranged thereon and corresponding in location to a damage-vulnerable surface of the vehicle; and installing an impact energy-absorbing guard into one or more of the one or more pockets. Once the base sheet of the vehicle cover is installed to about the vehicle; and the vehicle cover can be secured about the vehicle.

Once the event has passed, the method further comprises removing the base sheet from the vehicle and removing the guards from the pockets; and folding the base sheet and storing both the folded base sheet and removed guards.

### BRIEF DESCRIPTION OF THE DRAWINGS

FIG. 1 is a perspective view of a vehicle cover and removable impact-absorbing inserts installed therein, the cover arranged over a car having hood, roof and trunk area-located pockets, the trunk pocket being partially open for receiving or removing the impact-absorbing insert;

FIG. 2A is a perspective view of an edge opening of one pocket of a cover partially open for receiving a bubble wrap impact-absorbing insert;

FIG. 2B is a perspective view of an intermediate opening in a panel of one pocket of a cover partially open for receiving a foam sheet insert;

FIG. 2C is a perspective front view of a cover specific for a damage-vulnerable surface, such as a vehicle hood, the cover having three pockets all located to protect the hood, one of which shown with the opening in the open position and having a zippered fastener;

FIG. 3A is a perspective view of a vehicle cover installed on a pickup having hood, windshield pillars and roof area-located pockets;

FIG. 3B is a close up view of the drawstring cord ends for the cover of FIG. 3A;

FIG. 4A is a plan view of the vehicle cover of FIG. 1 with pillar inserts permanently incorporated into the cover, and hood, roof and trunk area-located pockets shown in the open position;

FIG. 4B is the cover of FIG. 4A in a folded arrangement for storage with removable inserts removed therefrom;

FIG. 4C is a view of the removable inserts of FIG. 4A arranged separate from the cover itself;

FIG. 5 is a side view of a vehicle cover installed on a motorcycle fuel tank; and

FIG. 6 is a stress strain curve illustrating the typical energy-absorbing behavior of a select few polymer foams of varying density.

### DESCRIPTION OF THE EMBODIMENTS

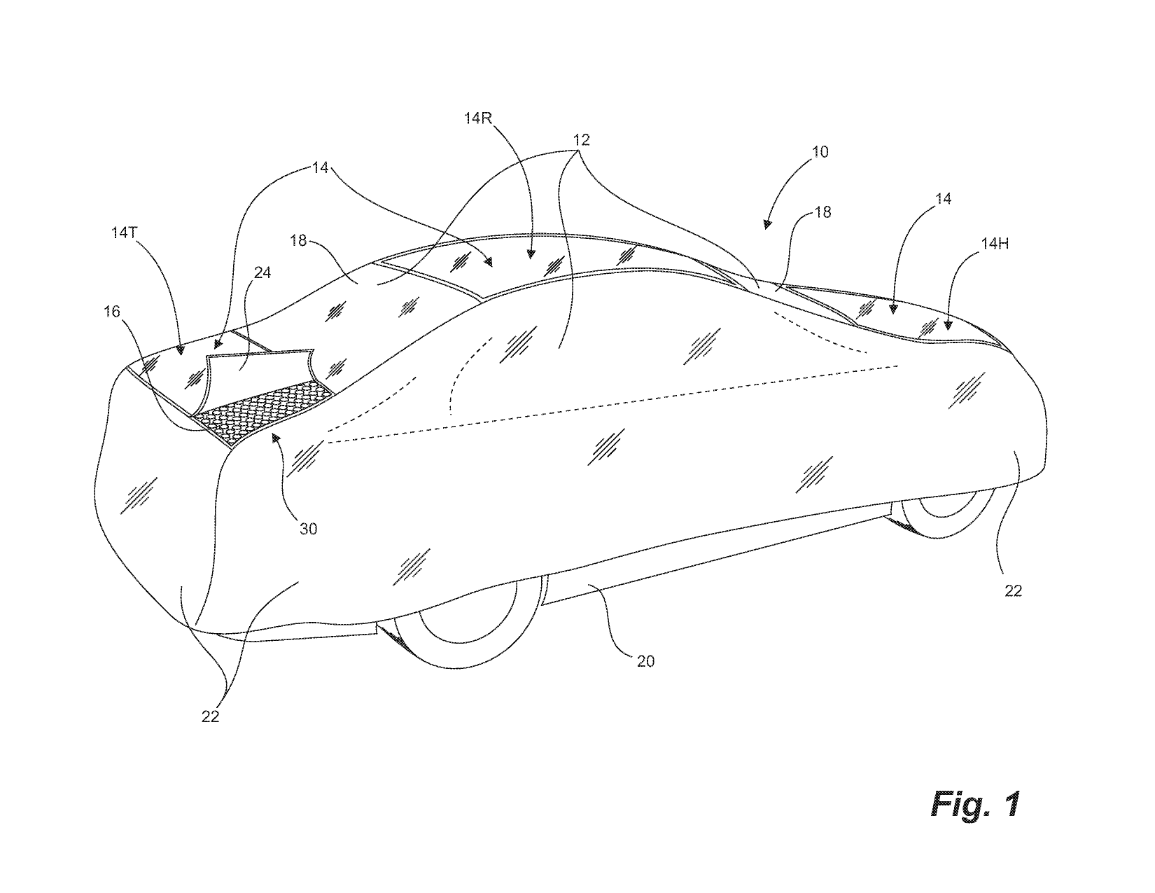

With reference to FIG. 1, a vehicle 20, such as a passenger car, is shown covered with an impact-mitigating cover 10 according to one embodiment. The cover 10 comprises a base sheet 12, one or more pockets 14, and energy or impact absorbing inserts or guards 16 for forming a storable vehicle cover 10. The base sheet 12 has one or more pockets 14 formed or secured thereon for the ease of insertion of the inserts 16. Some of the guards 16 are removably insertable into the pockets 14, others being permanently installed therein. The guards 16 can be removably insertable, temporarily inserted during an event, such as a hail storm, and removed thereafter for rendering the base sheet 12 as compact as possible for ease of storage. The base sheet 12 itself, the location of the pockets 14, or both, can be custom fit to the vehicle, or portion thereof, or to be a more generic to fit a variety of vehicles. The base sheet 12 can be retained to the vehicle 20. The cover system also serves as a general weather cover as is well known in the art.

The base sheet 12 is formed of material, such as a fabric. In an embodiment, the sheet material is of the lightweight form conventionally used for the covering of vehicles to protect from dust, rain, and snow. An example of cover fabric cover is polypropylene and a softer polyethylene inner layer against the vehicle finish. The fabric is also typically treated with UV inhibitors.

The shape and sizing of the base sheet 12 can be generic for a range of vehicle sizes or can be sized and shaped for a specific vehicle or a group of vehicles such as sedans, hatchbacks, Sports Utility Vehicles (SUVs), or trucks. Herein, the term vehicle cover, impact-mitigating or hail-mitigating cover means a cover for any form of vehicle, or damage-vulnerable surface thereon.

The base sheet 12 has at least an upper portion 18 for extending over the vehicle's vulnerable upper surfaces, and a skirt portion 22 thereabout and depending downward from the upper portion 18 to drape about at least a portion of the vehicle 20.

The base sheet 12 is fit with one or more of the pockets 14, arranged about the cover 12 so as to be located at areas corresponding to the vulnerable surfaces of the particular model of vehicle, typically corresponding to generally upper horizontal or angled sheet metal surfaces. Examples of vulnerable surfaces of a sedan include the hood, the roof and the trunk, all of which are upper surfaces of the vehicle. For a truck and an SUV, the hood and the roof are vulnerable. For a motorcycle, the gas tank is vulnerable. As shown in FIG. 1, pockets 14 are arranged about the base sheet 12 to correspond with the trunk lid, the roof, and the hood areas of a passenger car can be fit.

In some cases, the pockets 14 can be pre-fit with the guards 16. Other areas of the base sheet 12 can be fit with one or more pockets 14 that are only fit with guards 16 after the vehicle cover 10 is needed, such when installed or to the vehicle 20, and in some cases, fit immediately before or during a hail event. One pocket 14 over the trunk lid area, a truck pocket 14T, is shown open or partially open, for removably inserting a guard 16 therein.

The guards 16 can be sized to correspond with a particular pocket 14, or guars can be provided in a variety of smaller sizes that combined in side-by-side arrangement within a pocket, substantially fill the pocket. The size of a guard 16 or combination of guards, refers to the planer surface area corresponding to the pocket as the thickness of the guard is a matter of the material type and expected energy absorbing capability.

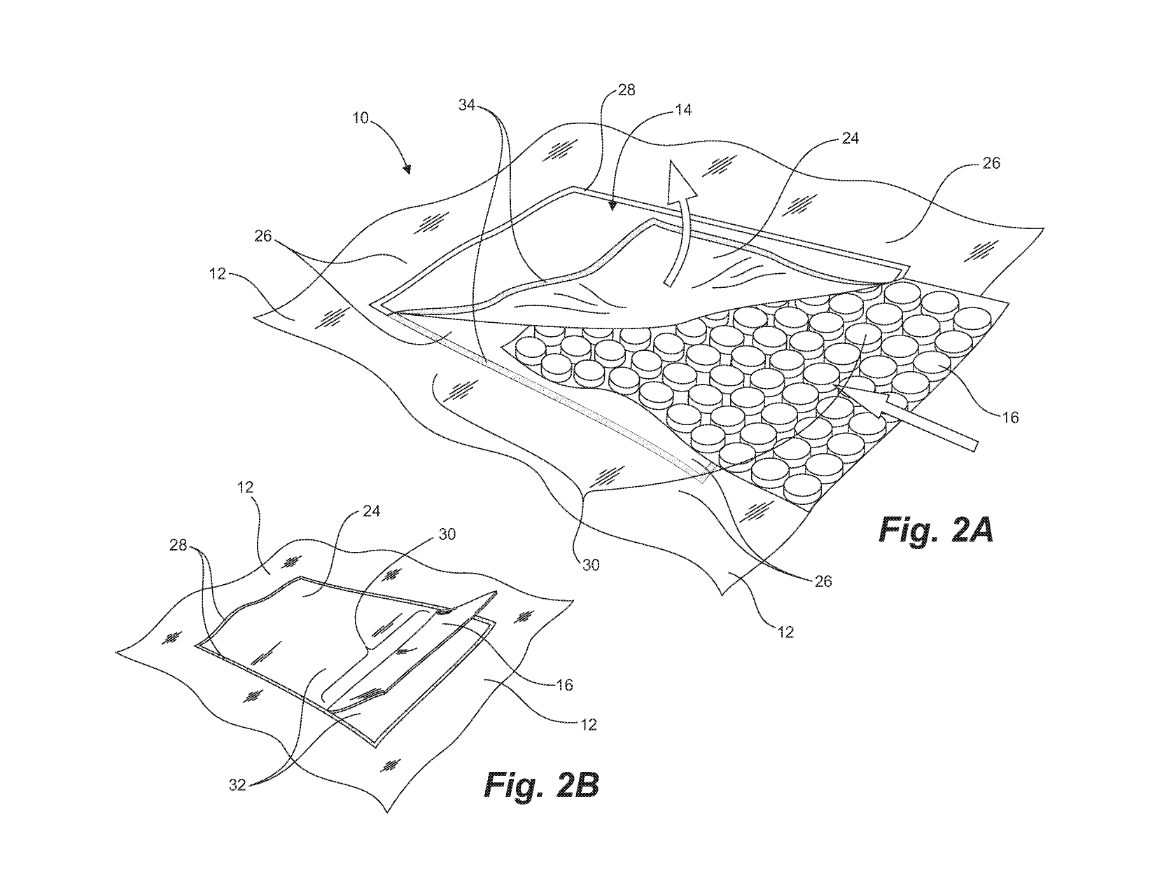

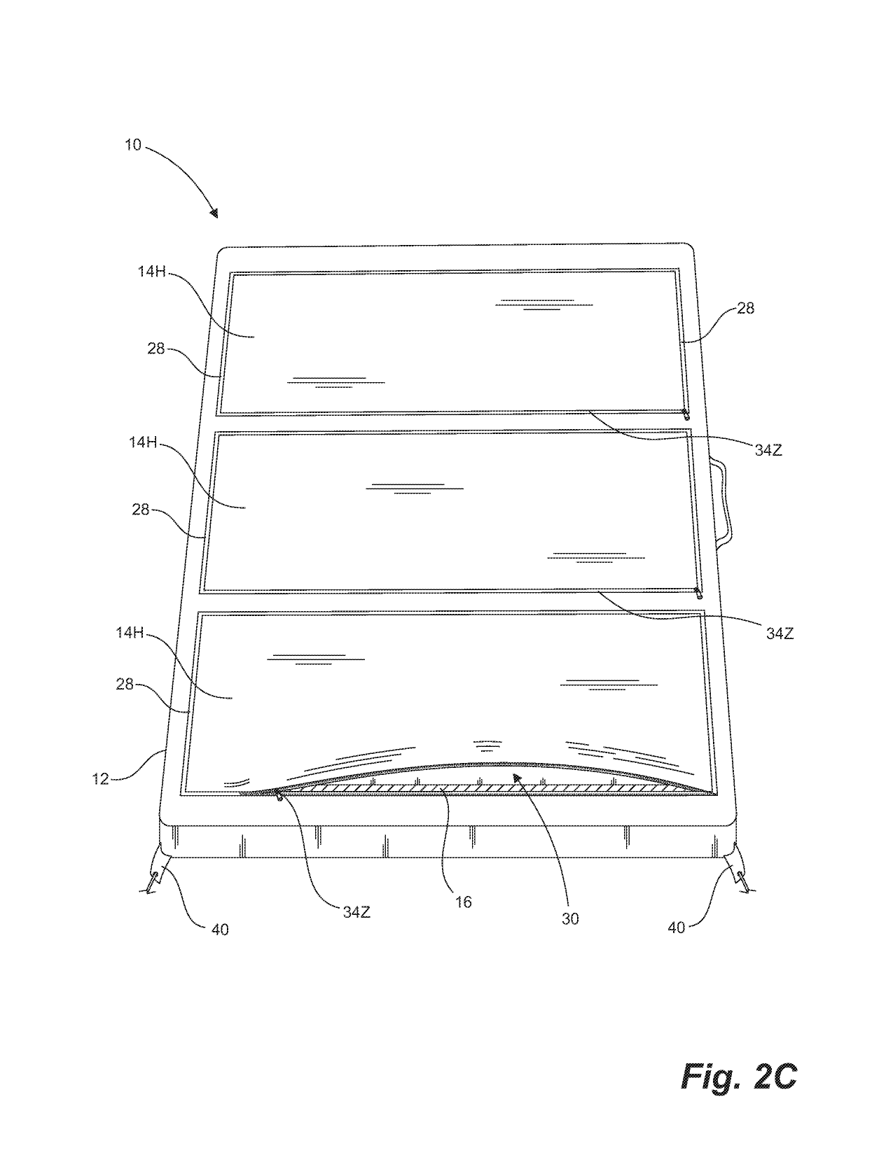

With reference to FIGS. 2A and 2B, in one embodiment, pockets 14 are formed by securing a first supplementary panel 14 to a second base panel 26, the guard-receiving void or pocket 14 being formed therebetween. The second base panel 26 is typically a portion of the base sheet 12 that corresponds with a vulnerable surface when installed to the vehicle. The supplementary panel 24 is peripherally secured or joined to the base panel 12. In one embodiment as shown in FIG. 2A, the supplementary panel 24 is peripherally secured or joined to the base panel with a substantially continuous seam 28 except for an interruption therealong for forming an access portion or opening 30.

Alternatively, as shown in FIG. 2B, the opening 30 can be made through an intermediate planer portion of a panel, the supplementary panel in this case, for access to the interior of the pocket. Such an intermediate opening can comprise overlapping portions of the panel for a more secure closure of the opening 30. The intermediate opening can also include fasteners for mechanical closure. In another embodiment, the base sheet can be a sandwich of several plays, and an intermediate opening 30 as above can provide access to a void between the plies.

As shown, the base panel 26 is a mere extension of the material of the base sheet 12. The supplementary panel 24 is an additional sheet of material, usually the same material as the base sheet 12. The pocket opening 30 or openings, whether along the seam 28 or periphery of the pocket 14, or through the panel 24 itself, can be fit with releasable fasteners 34, such as a zipper or hook and loop fasteners. In an embodiment, at least one edge, and up to all edges of the pocket 14, are fit with the releasable fasteners 34. As fasteners 34 along the seam 28 are labor intensive to install and are an added expense, typically the opening 30 is only fit to one or more side seams of a pocket or portion along a seam 28. If the opening 30 is smaller than the flexible impact-absorbing guard material for installation thereto, the opening 30 need not include fasteners as a compressed material will return to its original larger shape within the larger void of the pocket, being retained therein.

As shown in FIG. 2A, a rectangular pocket 14 is illustrated in an open position, having releasable fasteners 34 extending along at least two sides. The guard 16, formed of an impact-absorbing material, such as bubble wrap or foam, is shown in the process of installation or removal from the pocket. After installation, the upper supplementary panel 24 of the pocket 14 is fastened closed to the base panel 26, in this case along its edges using hook and loop fasteners.

With reference to FIG. 2C, a cover 10 need not be installed to the entirety of the vehicle but can be specific for a damage-vulnerable surface, such as a vehicle hood. To secure the cover 10 in place on the hood portion of the vehicle, straps 40 can be used to secure under the vehicle or clipped to a body or wheel component. As shown the cover is fit with three hood pockets 14H,14H,14H, all pockets located upon the base sheet 12 to protect the hood. One pocket 14H is shown with a zippered fastener 34Z, shown in a mostly open position for forming the opening 30 need to access the removable guard 16.

The guards 16 are selected from materials that generally absorb kinetic mechanical energy by compressing or deflecting at a relatively constant stress over an extended distance. While a variety of materials can be used, by design or by happenstance in an emergency, examples of those by design generally include neoprene, polyethylene, polyurethane, thermoplastic elastomers, and expanded polypropylene bead foams. One foam from The Dow Chemical Company, tradename IMPAXX™, is an extruded thermoplastic to produce a low-density, closed cell foam that meets a variety of ASTM test methods for impact. The foam is lightweight and can be compressed for storage. In principle, a foam with an appropriate thickness and compression strength is provided to absorb all of the energy of an impacting mass or masses such as hail stones. Accordingly, the vehicle surfaces beneath the guard 16 would never see a force higher than the foam crush strength, thus mitigating impact.

Herein, one suitable form of impact-absorbing material for hail mitigation is a thermal plastic rubber, in one layer or layered to about ¼″ in thickness. Such materials include the PORON® and XRD® branded materials by Rogers Corporation (Connecticut, USA) of microcellular polyurethane (PUR) foam products activated by impact to absorb a significant amount of energy.

In one study, by J. D. Koontz & Associates, Inc. a consultant in the roofing industry in New Mexico, an article, “HAIL: SIZING IT UP!”, By Vickie Crenshaw and Jim D. Koontz, cited an earlier hail researcher, J. A. P. Laurie, who correlated kinetic (impact) energies of hail. As shown below, Laurie graphed the relationship between terminal velocity, hail diameter, and the approximate kinetic (impact) energy, as follows:

TABLE 1
Terminal velocities and energies of hail stones

| | | |
|---|---|---|
| | | Approximate |
| Diameter | Terminal Velocity | Impact Energy |

| Inches | cm | ft/s | mi/hr | m/sec | ft lbs | Joules |
|---|---|---|---|---|---|---|
| 1 | 2.5 | 73 | 50 | 22.3 | <1 | <1.36 |
| 1¼ | 3.2 | 82 | 56 | 25.0 | 4 | 5.42 |
| 1½ | 3.8 | 90 | 61 | 27.4 | 8 | 10.85 |
| 1¾ | 4.5 | 97 | 66 | 29.6 | 14 | 18.96 |
| 2 | 5.1 | 105 | 72 | 32.0 | 22 | 29.8 |
| 2½ | 6.4 | 117 | 80 | 35.7 | 53 | 71.9 |
| 2¾ | 7.0 | 124 | 85 | 37.8 | 81 | 109.8 |
| 3 | 7.6 | 130 | 88 | 39.6 | 120 | 162.7 |

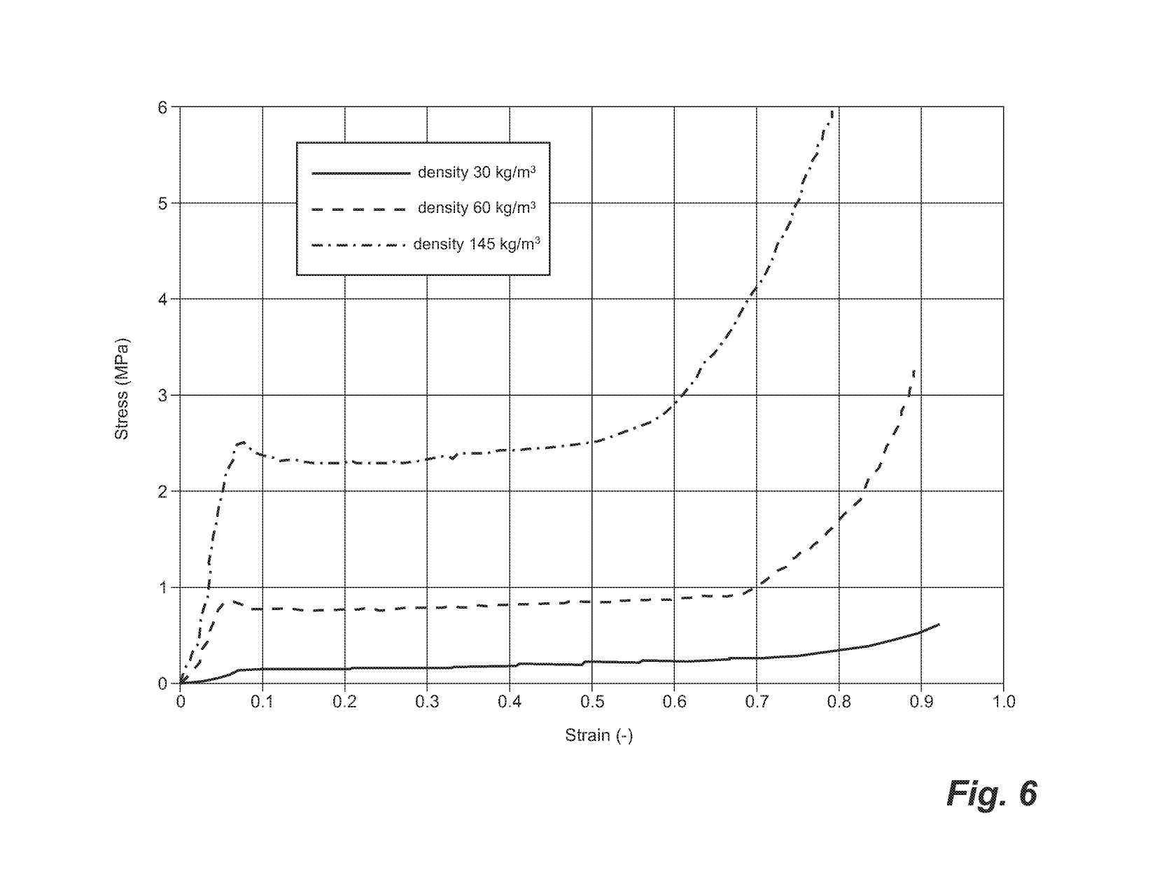

The energy-absorbing material of the guard 16 dissipates the kinetic energy of the impact while keeping the force on it below some limit, thus, resulting in a non-marking or plastic deformation of the structure beneath, in this case the sheet metal of the vehicle 20 or part thereof. The design of the base sheet 12, including the placement and sizing of the pockets 14 and guards 16 satisfies several of the variables related to the shape and impact angle of the cover 10 and the energy-absorbing guards 16 are selected to undergo large compressive deformations so as to absorb considerable amounts of specific energy. As shown in FIG. 6, stress strain curves of uniaxial compression of open-cell rigid polyurethane (PUR) foam is illustrated for densities ranging from 30, 60, and 145 kg/m3. Materials of different structures and density absorb differing amounts of energy and can be selected for the application.

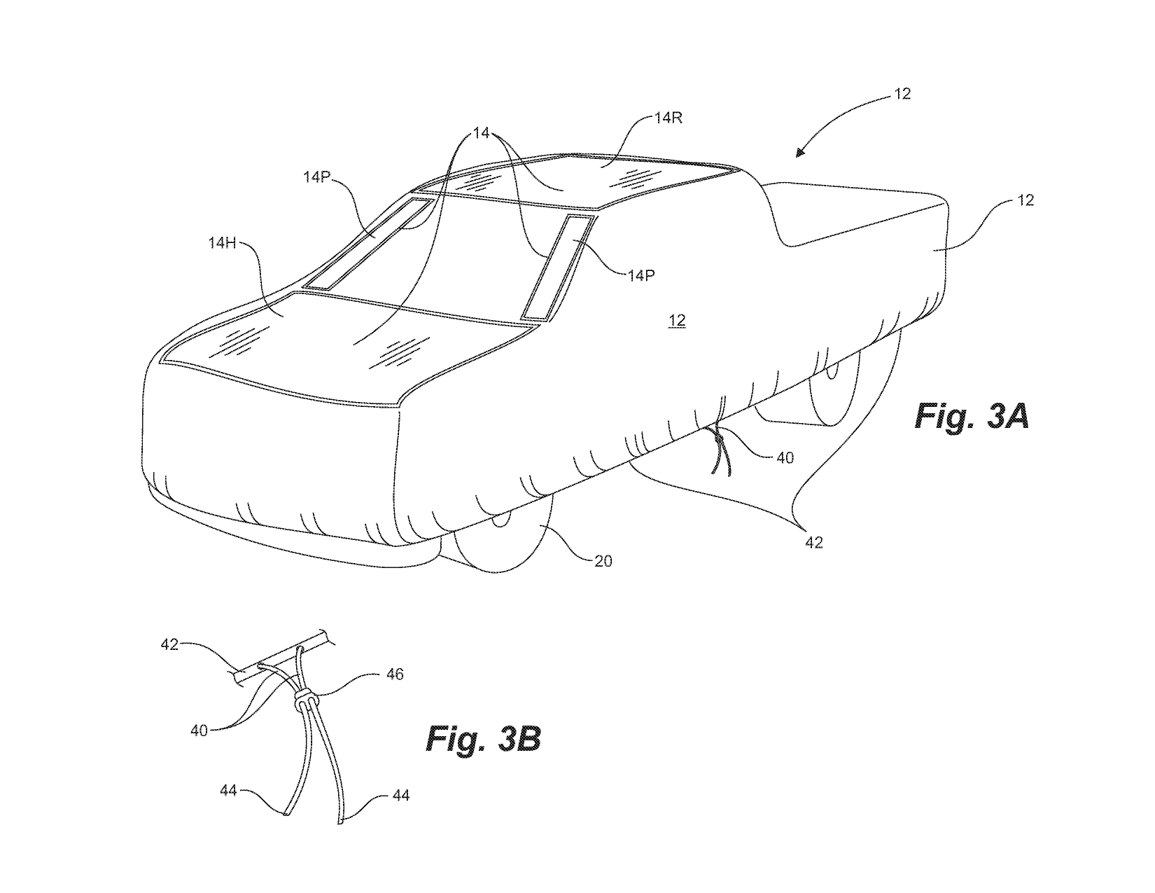

Turning to FIG. 3A, the base sheet 12 for a truck is fit with pockets 14 arranged at areas corresponding to the vulnerable surfaces of the truck vehicle, in this case a roof pocket 14R for the roof and a hood pocket 14H for the hood area. Again, the pockets 14 can be pre-fit with impact-absorbing material or guards, or the void of the pocket 14 can initially be empty, and only fit with guards 16 after the car cover 10 is installed, and in some cases, fit immediately before or during a hail event.

In most vehicles 20, pillars, at an angle from vertical and straddling the windshield, can also be vulnerable. The pillars are narrow and can be addressed in a particular manner. In this embodiment, small pillar pockets 14P straddling the windshield and extending along the windshield pillars are pre-fit with impact-absorbing guards 16. Two pillar pockets 14P are shown with integrated guards 16 that could be sewn into the pocket 14P. Due to the smaller size of the guards, there is little impetus, nor the economics to fit the pockets 14P with fasteners to make the pillar pockets recloseable. Other areas of a particular vehicle might have similar specific areas suitable for permanent guards.

The base sheet 12 of the impact-mitigating cover 10 can be retained with a securing device 40 such as a strap or drawstring that cinches about the lower periphery 42 thereof for retention of the cover 10 about the vehicle 20. Other embodiments might be secured by means of other clips or straps. As shown in FIG. 3B, cord ends 44,44 of the drawstring are releasably retained in a pinch toggle 46 or other such device. In an embodiment the pinch toggle or drawstring 40 can otherwise be lockable for security.

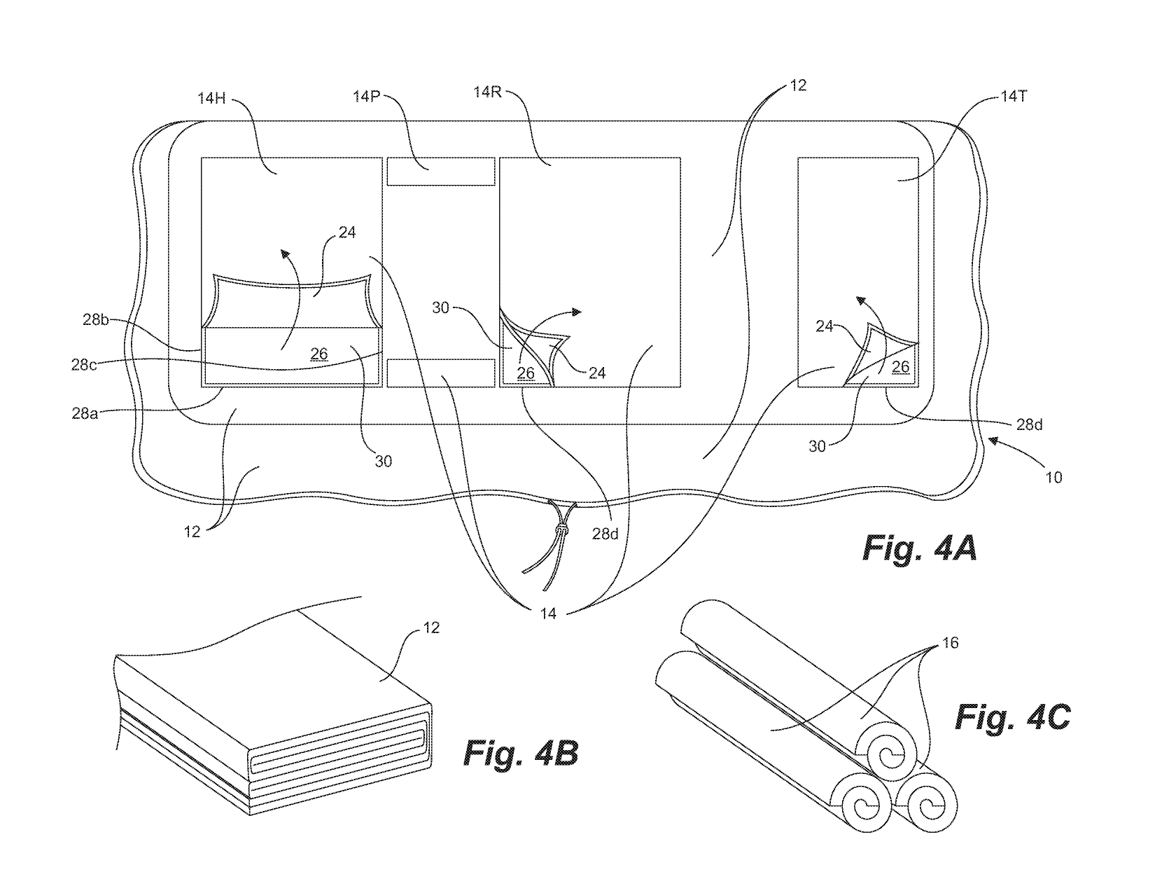

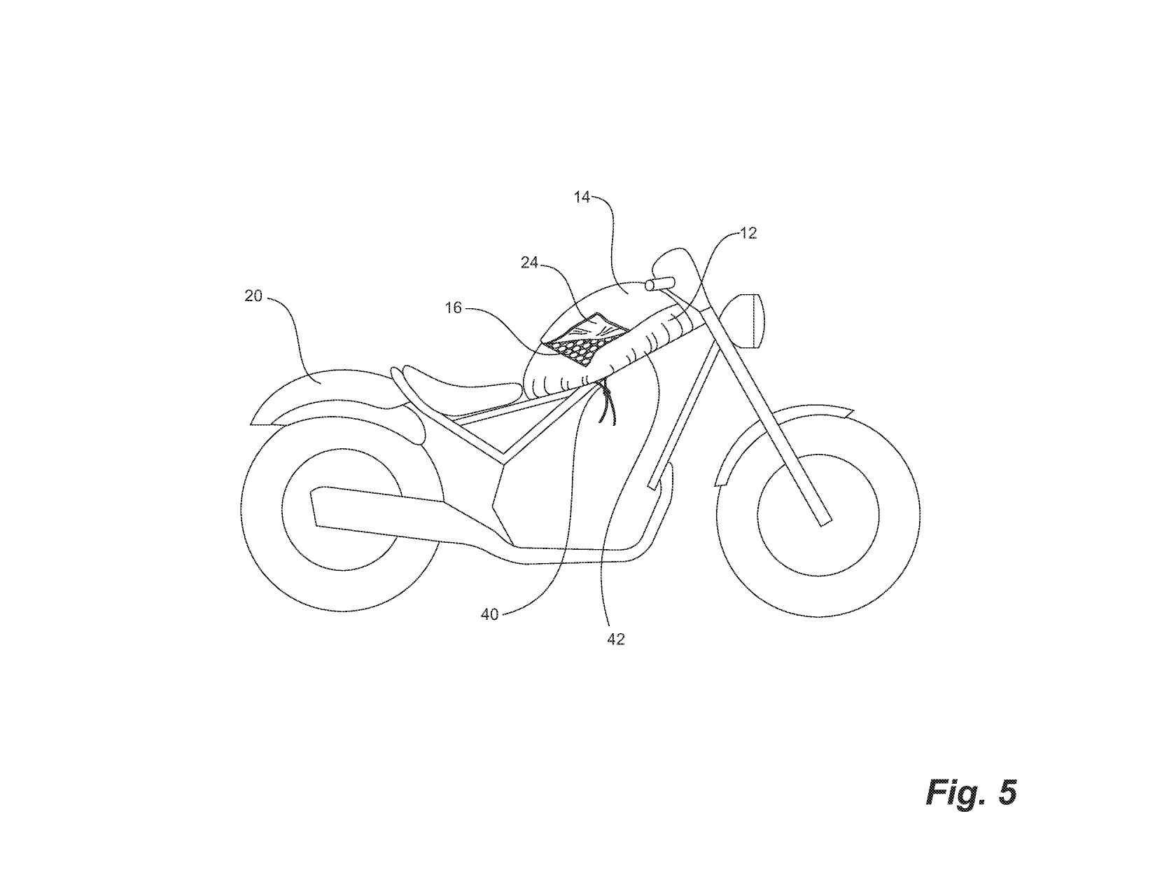

With reference to FIG. 4A, a plan view of a cover 10 is illustrated having hood pocket 14H on the hood panel with the opening 30 shown partially opened with releaseable fasteners 34 on the one side of the cover 10, and along at least a portion of two transverse seams 28. In addition, a roof pocket 14R and a trunk pocket 14T are shown with releaseable fasteners 34 at, at least, the corners of the respective pockets 14R,14T for forming the recloseable openings 30,30.

As stated, in embodiment, it is usually the larger of the guards 16 that are removable from their respective pockets so that: firstly the base sheet 12 can be foldable (See FIG. 4B) and compact, and secondly, so that any form of impact-absorbing material could be used as a guard 16 as required. It could be that ideal material for a guard, which would normally be provided with the cover 10 in a commercial retail embodiment, is not immediately handy at the time of need. In the case of a sudden hail event, one could place other handy or impromptu materials such as a blanket, already carried as part of a car-emergency kit, or an occupant's article of clothing such as a jacket or any other available energy-absorbing material, into one of more of the pockets 14. Any mitigation of the impact of hail would be appreciated by both the owner and their insurance provider.

With reference to FIG. 4B, the base sheet 12 of the cover system 10 can be folded into a compact shape for storage. As shown in FIG. 4C, commercial hail-mitigation covers 10 can be provided in combination with pre-sized guard material. As shown, three recloseable pockets 14,14,14 of FIG. 4A are coupled with three corresponding guards 16,16,16, shown here in rolled-up form, such as foam or bubble wrap.

The pockets 14 need not be closable with fasteners, if the base panel 26 and the supplemental panel 24 can at least temporarily retain the guard 16 therein, such has through a restrictive opening 30 to the pocket 14 or retaining interfaces between the panels 24,26.

The base sheet 12 of the impact mitigation cover 10 can be of any conventional design, however for the context of hail related protection, those covers with extra wind resistant aspects are preferred, including the drawstrings 40 of FIGS. 3A and 3B about the periphery to secure the cover about and to the vehicle's vulnerable surfaces.

As introduced above, the cover system 10 can be applied to a plurality of vulnerable areas or even to the entirety of the vehicle's exposed surfaces, as is the case for cars and trucks, or parts thereof, such as in the case of a car hood or to a motorcycle vehicle's gas tank.

With reference to FIG. 6, a motorcycle's gas or fuel tank is shown fit with a size-appropriate or smaller version of the cover system 10. Impact-absorbing guards 16 are typically flexible and one could use a single pocket fit with one guard to curve about the short radius of the tank compared to the usual flat profiles of a car or truck surface. However, for ease of handling one could also install several smaller guards 16,16 adjacent one another in one pocket 14, or, one could provide two pockets 14,14 for two guards 16,16. Two pockets 14,14 would also be ideal for an impromptu use of gloves or mitts as guards 16,16 fit to the pockets of the cover system.

In use, in advance or upon imminent risk of an event such as a hailstorm, one retrieves the base sheet 12 from storage and unfolds the base sheet for installation to the vehicle. The base sheet is installed about the vehicle with the one or more pockets arranged thereon and corresponding in location to a damage-vulnerable surface of the vehicle. Either before installation to the car, or once installed to, or about, the vehicle, one installs the impact energy-absorbing guard into one or more of the one or more pockets. Typically, depending upon the timing, one installs all guards corresponding to all the pockets. If so equipped, the cover can be secured to the vehicle using provided drawstring, cinches or straps.

After the event has passed, one removes the cover from the vehicle comprising removing the base sheet and removing the guards from the pockets. The base sheet can now be folded and the user can stores both the compact, folded base sheet and removed guards.

The embodiment of the invention for which an exclusive property or privilege is claimed are defined as follows:

1. An impact mitigation cover for a vehicle comprising:
a base sheet conforming in size and shape for securing about the vehicle or portion thereof; and
one or more pockets arranged on an outer surface thereon, each pocket corresponding in location to a damage-vulnerable surface of the vehicle and sized corresponding thereto, at least one of the pockets having an opening therein for the insertion of an correspondingly sized impact energy-absorbing guard therein for use, and for removal therefrom for storage.

2. The cover of claim 1, wherein two or more of the pockets correspond in location to the same damage-vulnerable surface of the vehicle.

3. The cover of claim 1, wherein the one or more pockets comprises two or more of the pockets, one of which is permanently fit with a guard.

4. The cover of claim 1, wherein:
one or more pockets comprises two or more pockets, and
the damage-vulnerable surfaces of the vehicle comprise at least a hood and a roof, two of the pockets being arranged on the cover to correspond to the hood and the roof.

5. The cover of claim 1, wherein each pocket opening is recloseable for securing the guard within the pocket.

6. The cover of claim 5, wherein the recloseable opening is fit with a releasable fastener.

7. The cover of claim 6, wherein each releasable fastener is a hook and loop fastener or a zipper.

8. Method for impact mitigation of a vehicle or portion thereof comprising:
unfolding a base sheet for a vehicle cover;
installing the base sheet about the vehicle or portion thereof with one or more pockets arranged thereon and corresponding in location to a damage-vulnerable surface of the vehicle; and
installing an impact energy-absorbing guard into one or more of the one or more pockets.

9. The method of claim 8, wherein the installing of a guard further comprises installing an energy absorbing material to the pocket.

10. The method of claim 9, wherein the energy absorbing material is selected having a planer surface area corresponding to the pocket.

11. The method of claim 9, wherein the energy absorbing material is selected from the group consisting of bubble wrap or foam.

12. The method of claim 9, wherein the material is selected from the group consisting of neoprene, polyethylene, polyurethane, expanded polypropylene bead, and thermoplastic elastomers.

13. The method of claim 9, wherein the material is a microcellular polyurethane foam.

14. The method of claim 9, wherein the energy absorbing material is impromptu material is selected from the group consisting of articles of clothing, wraps and blankets.

15. The method of claim 8, further comprising:
removing the base sheet from the vehicle and removing the guards from the pockets; and
folding the base sheet and storing both the folded base sheet and removed guards.

16. The method of claim 8, wherein once the base sheet of the vehicle cover is installed to about the vehicle, securing the vehicle cover about the vehicle.
